(19) United States
(12) Patent Application Publication
(10) Pub. No.: US 2025/0245800 A1
(43) Pub. Date: Jul. 31, 2025

(54) ROBUST AUTOMATIC IMAGE AND VIDEO QUALITY ASSESSMENT

(71) Applicant: GOOGLE LLC, Mountain View, CA (US)

(72) Inventors: Yilin Wang, Sunnyvale, CA (US); Boqing Gong, Bellevue, WA (US); Balineedu Adsumilli, Sunnyvale, CA (US); Xiaojun Xu, Santa Clara, CA (US)

(21) Appl. No.: 18/428,393

(22) Filed: Jan. 31, 2024

(51) Int. Cl. G06T 7/00; G06T 3/40; G06V 10/764; G06V 10/774; G06V 10/776

(52) U.S. Cl. CPC G06T 7/0002; G06T 3/40; G06V 10/764; G06V 10/774; G06V 10/776; G06T 2207/10016; G06T 2207/20081; G06T 2207/30168

(57) ABSTRACT

Obtaining a robustly trained image quality assessment machine learning model by training a machine learning model using a target image obtained by upscaling a downscaled reference image, an adversarial image obtained by upscaling a result of distorting the downscaled image, obtaining, from the machine learning model with first parameter values, a first result value for the target image relative to the reference image and a second result value for the adversarial image relative to the reference image, including, in the machine learning model, a result of subtracting a scaled gradient from the first parameter values, wherein the scaled gradient is a result of a product of a gradient of a loss function that is a maximum among zero and a result of adding a defined hinge loss value to difference between the result values.

### BACKGROUND

Digital images and video can be used, for example, on the internet, for remote business meetings via video conferencing, high-definition video entertainment, video advertisements, or sharing of user-generated content. Systems that store, process, distribute, or otherwise access digital visual media, such as images, video, or both, may utilize quality data to optimize performance, improve accuracy, and minimize resource utilization. Accordingly, techniques for automating image and video quality assessment would be advantageous.

### SUMMARY

This application relates to automatically assessing the quality of image data, video data, or both. Disclosed herein are aspects of systems, methods, and apparatuses for robust automatic image and video quality assessment.

Variations in these and other aspects will be described in additional detail hereafter.

An aspect is a method for robust automatic image and video quality assessment. Robust automatic image and video quality assessment may include obtaining a trained image quality assessment machine learning model by training a machine learning model using first training data including a reference image. Training the machine learning model may include obtaining a target image by upscaling a downscaled image obtained by downscaling the reference image. Training the machine learning model may include obtaining an adversarial image by upscaling an optimized distorted image obtained by distorting the downscaled image. Training the machine learning model may include obtaining, from the machine learning model with first parameter values, a first result value for the target image relative to the reference image. Training the machine learning model may include obtaining, from the machine learning model with the first parameter values, a second result value for the adversarial image relative to the reference image. Training the machine learning model may include obtaining, as second parameter values, a result of subtracting a scaled gradient from the first parameter values, wherein the scaled gradient is a result of a product of a defined learning rate value and a gradient of a loss function with respect to the first parameter values for the reference image, wherein the loss function is a maximum among zero and a result of adding a defined hinge loss gap hyper-parameter value to a result of subtracting the first result value from the second result value. Training the machine learning model may include including the second parameter values in the machine learning model.

An aspect is an apparatus for robust automatic image and video quality assessment. The apparatus includes a non-transitory computer readable medium and a processor configured to execute instructions stored on the non-transitory computer readable medium. The processor may execute the instructions to obtain a trained image quality assessment machine learning model, wherein, to obtain the train image quality assessment machine learning model, the processor executes the instructions to train a machine learning model using first training data including a reference image. To train the machine learning model, the processor may execute the instructions to obtain a target image, wherein, to obtain the target image, the processor executes the instructions to upscale a downscaled image, wherein, to obtain the downscaled image, the processor executes the instructions to downscale the reference image. To train the machine learning model, the processor may execute the instructions to obtain an adversarial image, wherein, to obtain the adversarial image, the processor executes the instructions to upscale an optimized distorted image, wherein, to obtain the optimized distorted image, the processor executes the instructions to distort the downscaled image. To train the machine learning model, the processor may execute the instructions to obtain, from the machine learning model with first parameter values, a first result value for the target image relative to the reference image. To train the machine learning model, the processor may execute the instructions to obtain, from the machine learning model with the first parameter values, a second result value for the adversarial image relative to the reference image. To train the machine learning model, the processor may execute the instructions to obtain, as second parameter values, a result of subtraction of a scaled gradient from the first parameter values, wherein the scaled gradient is a result of a product of a defined learning rate value and a gradient of a loss function with respect to the first parameter values for the reference image, wherein the loss function is a maximum among zero and a result of addition of a defined hinge loss gap hyper-parameter value to a result of subtraction of the first result value from the second result value. To train the machine learning model, the processor may execute the instructions to include the second parameter values in the machine learning model.

An aspect is a non-transitory computer-readable storage medium, comprising executable instructions that, when executed by a processor, facilitate performance of operations, comprising obtaining a trained image quality assessment machine learning model by training a machine learning model using first training data including a reference image. Training the machine learning model may include obtaining a target image by upscaling a downscaled image obtained by downscaling the reference image. Training the machine learning model may include obtaining an adversarial image by upscaling an optimized distorted image obtained by distorting the downscaled image. Training the machine learning model may include obtaining, from the machine learning model with first parameter values, a first result value for the target image relative to the reference image. Training the machine learning model may include obtaining, from the machine learning model with the first parameter values, a second result value for the adversarial image relative to the reference image. Training the machine learning model may include obtaining, as second parameter values, a result of subtracting a scaled gradient from the first parameter values, wherein the scaled gradient is a result of a product of a defined learning rate value and a gradient of a loss function with respect to the first parameter values for the reference image, wherein the loss function is a maximum among zero and a result of adding a defined hinge loss gap hyper-parameter value to a result of subtracting the first result value from the second result value. Training the machine learning model may include including the second parameter values in the machine learning model.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream in accordance with implementations of this disclosure.

FIG. 4 is a flowchart diagram of an example of robust automatic image and video quality assessment in accordance with implementations of this disclosure.

### DETAILED DESCRIPTION

Automatic image and video quality assessment includes automatically determining, calculating, measuring, or otherwise obtaining quality data quantifying the perceptual quality of images, videos, or both, such as using one or more image, or video, quality assessment machine learning models, such that the automatically generated quality data is representative of a probable manual quality rating for the image, or video. Image, or video, quality assessment machine learning models are trained using training data that includes training examples, such as images, videos, or both labeled, such as manually labeled, with respective subjective quality rating data. The accuracy of an image, or video, quality assessment machine learning model may correlate with the size, or cardinality, of the set of training examples in the training data. The size, or cardinality, of the set of training examples in the training data and the relative complexity of the subjective evaluation thereof correlates with the resource utilization for obtaining the training data, such that the size, or cardinality, of a set of training examples in the training data for training an image, or video, quality assessment machine learning model may be relatively small as compared to the size, or complexity, of the sets of training examples in the training data for other types of machine learning models, such as machine learning classification models.

Training, or tuning, a machine learning model, such as an image, or video, quality assessment machine learning model, may include using the machine learning model to obtain automatically generated results data for the training data, such as automatically generated quality data quantifying the perceptual quality of the training data, such as training images, videos, or both, and updating, modifying, or revising, one or more parameters, such as probabilities, such as weights and biases, of the image, or video, quality assessment machine learning model in accordance with the accuracy of the automatically generated results data relative to the corresponding subjective assessment thereof, such as on a per-training element, such as a per-training image, or per-training video, basis. Training a machine learning model with respect to the elements, such as images or videos, of a set of training data may be referred to as an epoch and training the machine learning model may include multiple epochs, such as a defined number, count, or cardinality, of epochs. For simplicity and clarity, labeled training examples, such as training images or training videos, are referred to herein as reference training examples.

Robust automatic image and video quality assessment, as described herein, includes the robustification of machine learning models to improve the accuracy thereof relative to similar models in the absence of the robustification described herein. The robustification includes augmenting the training data with automatically generated adversarial training examples, wherein a respective automatically generated adversarial training example is associated with a corresponding reference training example and has relatively low quality relative to the corresponding reference training example, generated such that, prior to the robustification, the machine learning model demonstrably inaccurately assess the relatively low quality automatically generated adversarial training examples as having higher quality than the corresponding relatively high quality reference training examples and, subsequent to the training, the robustly trained machine learning model accurately assess the relatively low quality automatically generated adversarial training examples as having lower quality than the corresponding relatively high quality reference training examples.

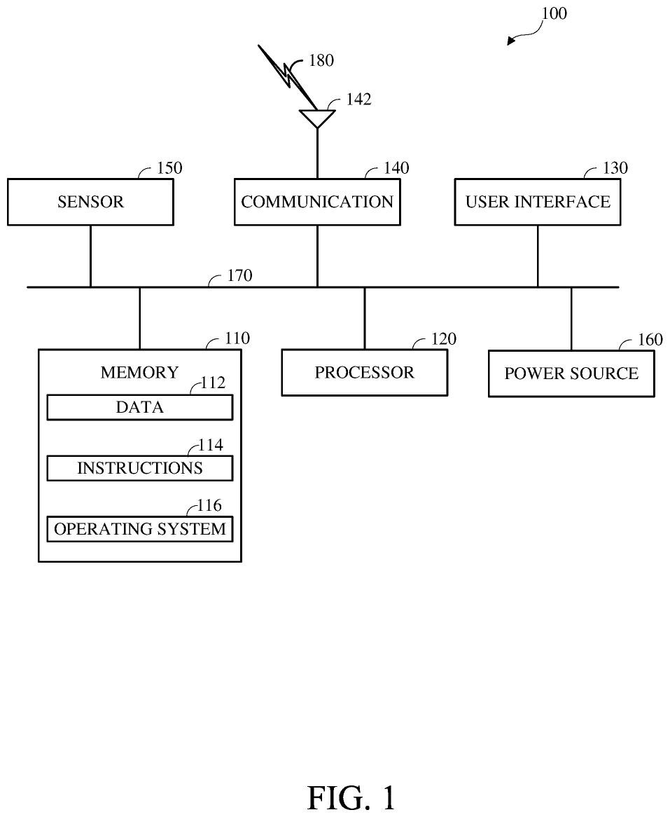

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100 the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

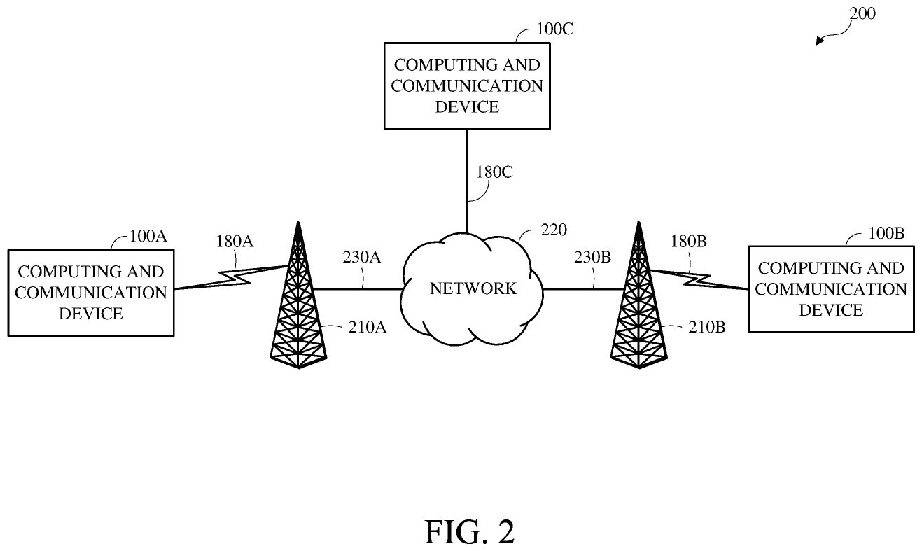

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VoIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

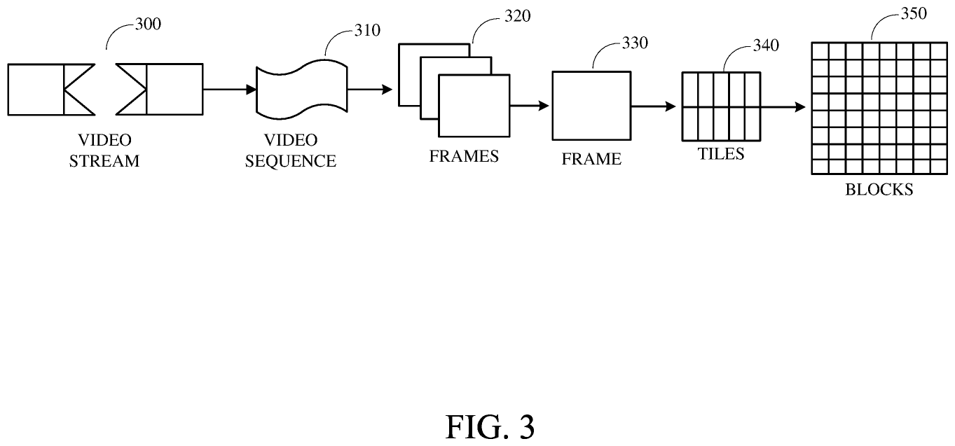

FIG. 3 is a diagram of a video stream 300 in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

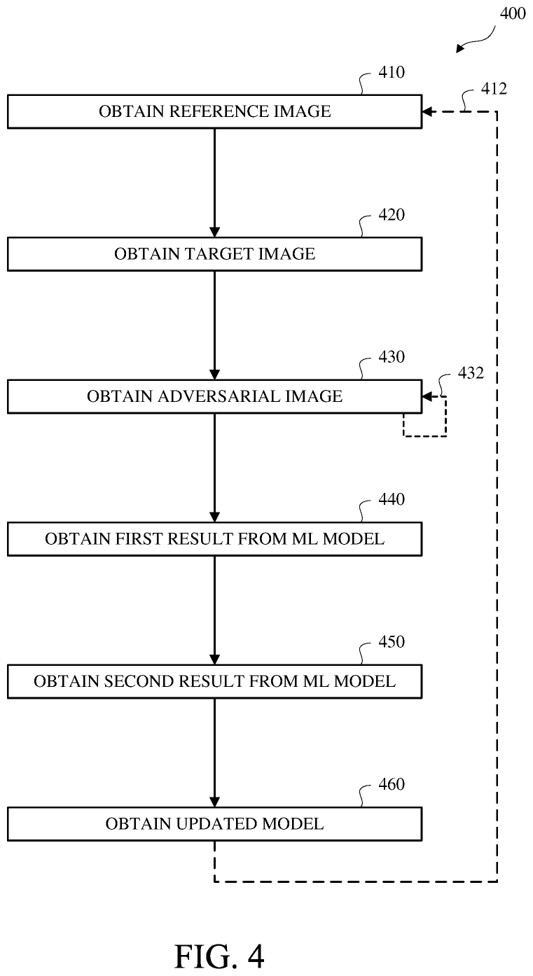

FIG. 4 is a flow diagram of an example of robust automatic image and video quality assessment 400 in accordance with implementations of this disclosure. Robust automatic image and video quality assessment 400 may be implemented by a computing device, such as the computing device 100 shown in FIG. 1, or a computing and communications system, such as the computing and communications system 200 shown in FIG. 2.

Robust automatic image and video quality assessment 400 includes obtaining a trained image quality assessment machine learning model. Obtaining the trained image quality assessment machine learning model includes training a machine learning model. Training the machine learning model includes using training data (first training data). Training the machine learning model includes obtaining a reference image (at 410), obtaining a target image (at 420), obtaining an adversarial image (at 430), obtaining first results at (at 440), obtaining second results at (at 450), and obtaining an updated model (at 460). Although not shown expressly in FIG. 4, robust automatic image and video quality assessment 400 includes other aspects of image quality assessment, video quality assessment, or both.

Obtaining the first training data (at 410) includes obtaining a set of previously labeled, such as manually, or human, labeled training examples. For example, the first training data may include labeled training images, labeled training videos, or both. Obtaining the first training data (at 410) includes obtaining a reference image from the first training data.

In some implementations, the machine learning model is an image quality assessment machine learning model, and the first training data includes labeled training examples (reference examples) labeled with quality assessment data. The quality assessment data for a respective labeled training example may include a corresponding subjective quality score. The subjective quality score may be an aggregate, such as an average, mean, or median, score obtained using multiple manual assessments. The labeled training data for the image quality assessment machine learning model may have a relatively small size, indicating a relatively small number, count, or cardinality of labeled training examples. For example, obtaining the first training data may include obtaining a reference image (y) from the first training data.

In some implementations, the machine learning model is a backbone machine learning model, such as a machine learning classification model, and the first training data includes labeled training examples (reference examples) labeled with classification probability data. The classification probability data may include classification probabilities for multiple classes. The classification probability data may include aggregate, such as an average, mean, or median, classification probability data obtained using multiple manual classifications. The quality assessment data for a respective labeled training example may include corresponding classification probability data. The labeled training data for the backbone machine learning model may have a relatively large size, indicating a relatively large number, count, or cardinality of labeled training examples.

A downscaled image (z) may be obtained by downscaling an image (x), such as by a defined downscaling factor (γ), wherein the defined downscaling factor (γ) is greater than one (γ>1), such as (γ=1.5), which may be expressed as z=D(x). An upscaled image (\tilde{x}) may be obtained by upscaling an image, such as the downscaled image (z), such as to the size of the reference image (x), which may be expressed as \tilde{x}=U(z).

Obtaining the target image (at 420) includes obtaining a target image (y₀′) by upscaling a downscaled image obtained by downscaling the reference image, which may be expressed as y₀′=U(D(y)).

Obtaining the adversarial image at (at 430) includes obtaining an adversarial image by upscaling an optimized distorted image obtained by distorting the downscaled image.

With respect to a distorted image (x) and an undistorted reference image (y), wherein the size and shape of the distorted image (x) and the reference image (y) match, the image quality assessment machine learning model, or quality metric, may be expressed as ƒ(x, y)∈ [symbol] . The quality metric (ƒ(x, y)) may be differentiable, such that a partial derivative ∂ƒ/∂x may be calculated.

The distorted image is an adversarial training example, wherein the quality metric (ƒ(x, y)) is accessible (e.g., as white-box information) to the adversary. The reference image (y) is accessible (e.g., as white-box information) to the adversary. The adversary may simulate the quality metric. The adversary may obtain, such as calculate or determine, a gradient of the quality metric ∂ƒ/∂x. The adversarial training example, or distorted image, ( ) is obtained by upscaling a sum, obtained in the downscaled space, of the downscaled image (z) and a perturbation (δ) having the size of the downscaled image (z), which may be expressed as x′=U(z+δ).

The adversary obtains an adversarial example (x′) that maximizes the quality metric ((ƒ(x′, y)), subject to defined constraints, such as x′< >y.

Obtaining the adversarial example may be expressed as obtaining an optimized perturbation (δ) in an optimization goal, which may be expressed as the following:

$${arg max}_{{‖ δ ‖}_{2} < ϵ} f ( U ( D ( x ) + δ ) , y ) .$$

Obtaining the adversarial example may include using a gradient descent technique, such as a projected gradient descent (PGD) technique, which may include multiple iterations, as indicated by the broken directional line (at 432) to obtain an optimized perturbation (δ_{T}) as a result of perturbation optimization. A respective iteration (t) of perturbation optimization obtains, such as calculates, generates, or determines, a candidate perturbation (δₜ) using a previously obtained perturbation (δₜ₋₁).

Prior to, or as input to, a first iteration (t=1), the previously obtained perturbation (δ₀) may be zero (δ₀=0). Obtaining a respective candidate perturbation (δₜ) includes using a defined step size value (α), such as ten (α=10.0). Obtaining the respective candidate perturbation (δₜ) includes obtaining, from the machine learning model, or quality metric, with first parameter values, such as probabilities and biases, a respective result value, or quality score, for the downscaled training image relative to the reference image, which may be expressed as ƒ(U(D(x)), y).

In some iterations, obtaining the respective candidate perturbation (δₜ) includes obtaining a respective unconstrained candidate perturbation (\tilde{δ}ₜ) and constraining the unconstrained candidate perturbation (\tilde{δ}ₜ), such as in accordance with a defined norm constraint value (∈), such as (∈=+∞), with respect to the Euclidean norm of the current perturbation (∥δ∥₂), which may be expressed as (∥δ∥₂<∈), to obtain the candidate perturbation (δₜ). In some implementations, the constraint may be omitted, skipped, or excluded.

In a first iteration, obtaining a first candidate perturbation (δ₁) may include obtaining, from the machine learning model (ƒ(U(D(x)), y)), a backpropagated matrix for the target image relative to the reference image, and obtaining, as the first candidate perturbation (δ₁), a product of the defined step size value (α) and the backpropagated matrix, which may be expressed as the following:

$${δ}_{1} = α * f ( U ( D ( x ) ) , y ) .$$

In a subsequent iteration of perturbation optimization, subsequent to the first iteration, obtaining the respective candidate perturbation (δₜ), which may be a corresponding unconstrained candidate perturbation (\tilde{δ}ₜ), or current perturbation for simplicity, may include obtaining a sum of the previously obtained perturbation (δₜ−1) and a product of the defined step size value (α) and a partial derivative, with respect to the previously obtained perturbation (\tilde{δ}ₜ), of the machine learning model with respect to the reference image as applied to a current distorted image obtained by upscaling a sum of the downscaled image (x) and the previously obtained perturbation (\tilde{δ}ₜ), which may be expressed as the following:

$${\tilde{δ}}_{r} = {δ}_{t - 1} + α \cdot \frac{\partial f ( U ( D ( x ) + {δ}_{t - 1} ) , y )}{{δ}_{t - 1}} .$$

The respective candidate perturbation (δₜ) may be obtained by clipping the corresponding unconstrained candidate perturbation (\tilde{δ}ₜ) in accordance with the defined norm constraint value, which may include obtaining, as the current perturbation (δₜ), a result of a product of the corresponding unconstrained candidate perturbation (\tilde{δ}ₜ) and a result of dividing a minimum among a defined norm constraint value (∈) and a Euclidean norm of the current perturbation (∥δ∥₂) by the Euclidean norm of the current perturbation (∥δ∥₂), which may be expressed as the following:

$${δ}_{t} = \frac{min ( ϵ , {‖ {\tilde{δ}}_{t} ‖}_{2} )}{{‖ {\tilde{δ}}_{t} ‖}_{2}} \cdot {( \tilde{δ} )}_{t} .$$

The distorted image, or adversarial example, with respect to an iteration (t) may be expressed as xₜ′=U(D(x)+δₜ). The optimized distorted image, or optimized adversarial example, (adversarial image) may be expressed as x_{T}′=U(D(x)+δ_{T}).

Iteratively obtaining the optimized perturbation (δ_{T}) by perturbation optimization may include determining whether an exit condition is satisfied. The exit condition may be one of multiple defined exit conditions.

In some implementations, determining whether the exit condition is satisfied may include determining whether the gradient is zero. For example, perturbation optimization may include determining that the exit condition is satisfied in response to a determination that, or on a condition that, the gradient is zero. In another example, perturbation optimization may include determining that the exit condition is unsatisfied in response to a determination that, or on a condition that, the gradient is other than zero.

In some implementations, respective iterations of perturbation optimization may include incrementing a perturbation optimization iteration count value, and determining whether the exit condition is satisfied may include determining whether the perturbation optimization iteration count value is less than a defined maximum iterations threshold, such as one thousand. For example, perturbation optimization may include determining that the exit condition is satisfied in response to a determination that, or on a condition that, the perturbation optimization iteration count value is greater than or equal to the defined maximum iterations threshold. In another example, perturbation optimization may include determining that the exit condition is unsatisfied in response to a determination that, or on a condition that, the perturbation optimization iteration count value is less than the defined maximum iterations threshold.

In some implementations, perturbation optimization may include determining that the exit condition is satisfied in response to a determination that, or on a condition that, the gradient is zero or in response to a determination that, or on a condition that, the perturbation optimization iteration count value is greater than or equal to the defined maximum iterations threshold, and may include determining that the exit condition is unsatisfied in response to a determination that, or on a condition that, the gradient is other than zero and in response to a determination that, or on a condition that, the perturbation optimization iteration count value is less than the defined maximum iterations threshold.

Obtaining the first results at (at 440) includes obtaining, from the machine learning model with the first parameter values (θ), a first result value for the target image relative to the reference image.

In some implementations, the machine learning model is an image, or video, quality assessment machine learning model and training the image, or video, quality assessment machine learning model includes using an attack-aware defense. In some implementations, the machine learning model is a backbone model of the image, or video, quality assessment machine learning model and training the backbone model includes using an attack-agnostic defense.

In some implementations, the machine learning model may have a target metric, such as peak signal to noise ratio (PSNR), structural similarity index measure (SSIM), visual information fidelity (VIF), or Learned Perceptual Image Patch Similarity (LPIPS).

In some implementations, the image quality assessment machine learning model is a reference metric, such as the Learned Perceptual Image Patch Similarity (LPIPS) metric. The Learned Perceptual Image Patch Similarity (LPIPS) model is a deep learning-based metric including, or incorporating, a pretrained convolutional neural network backbone model. The backbone model of the Learned Perceptual Image Patch Similarity (LPIPS) model may be a classification model, such as the Visual Geometry Group sixteen-layer model (VGG-16), which is a sixteen-layer convolutional neural network model.

For example, for the Learned Perceptual Image Patch Similarity (LPIPS) model, the optimized perturbation (δ_{T}) may be a colorful texture pattern.

For example, obtaining, from the machine learning model with the first parameter values (θ), the first result value for the target image relative to the reference image may be expressed as ƒ_{L}(x, y; θ). The set of training examples, which may be training images or training videos, from the training data may be expressed as {yᵢ}.

With respect to the trained image, or video, quality assessment machine learning model, the result value, or quality score, for the target image relative to the reference image (ƒ_{L}(U(D(y)), y)) is greater than the result value, or quality score, for the adversarial image relative to the reference image (ƒ_{L}(U(D(y)+δ, y)).

Obtaining the second results at (at 450) includes obtaining, from the machine learning model with the first parameter values (θ), a second result value for the adversarial image relative to the reference image.

Obtaining the updated model (at 460) includes obtaining, as second parameter values, a result of subtracting a scaled gradient from the first parameter values, wherein the scaled gradient is a result of a product of a defined learning rate value (lr), such as 0.1, and a gradient of a loss function ( [symbol] (θ; y)) with respect to the first parameter values for the reference image (∇_{θ} [symbol] (θ; y)). The loss function ( [symbol] (θ; y)) may be obtained as a result of a hinge loss function ([α]⁺), that obtains a maximum among alpha (a) and zero, which may be expressed as [α]⁺=max(α,0), wherein alpha (α) is a result of adding a defined hinge loss gap hyper-parameter value (γ) to a result of subtracting the first result value ƒ_{L}(y₀′, y) from the second result value ƒ_{L}(yₜ′, y), which may be expressed as the following:

$$ℓ ( θ ; y ) = {[ {f}_{L} ( {y}_{t}^{′} , y ) - {f}_{L} ( {y}_{0}^{′} , y ) ]}^{+} .$$

Obtaining the updated model (at 460) includes including the second parameter values in the machine learning model, which may be expressed as the following:

$$θ = θ - lr \cdot {∇}_{θ} ℓ ( θ ; y ) .$$

For example, the model may identify a relatively high assessment, or similarity score, for the adversarial image (yₜ′) relative to the assessment, or similarity score, for the target image (y₀′), and the loss function may train the model lower the assessment, or similarity score, for the adversarial image (ƒ_{L}(yₜ′, y)) and increase the assessment, or similarity score, for the target image (ƒ_{L}(y₀′,y)).

In some implementations, the first training data includes a plurality of training images, including the reference image and training the machine learning model includes training the machine learning model on a per-training image basis with respect to the plurality of training images.

In some implementations, the trained image quality assessment machine learning model is a trained video quality assessment machine learning model, the first training data includes a plurality of training videos, including a first training video, wherein the reference image is a first frame of the first training video, and training the machine learning model includes training the machine learning model on a per-training video with respect to the plurality of training videos.

Training a machine learning model with respect to the set of examples in the training data may be referred to as an epoch, and training the machine learning model may include multiple epochs. For example, the video quality assessment machine learning model may be trained using a defined learning rate value (lr), such as 0.1, for twenty epochs. In another example, the backbone machine learning model may be trained using a defined learning rate value (lr), such as 0.001, for ten epochs. In some implementations, training a video quality assessment machine learning model may include training with respect to a proper subset of frames of the video.

Although not shown separately in FIG. 4, in some implementations, the machine learning model is the backbone machine learning model, such as a machine learning classification model, obtaining the trained image quality assessment machine learning model includes obtaining an image quality assessment machine learning model that includes the machine learning model as a backbone model, training the machine learning model includes training the backbone model as shown in FIG. 4, and, subsequent to training the machine learning model, obtaining the trained image quality assessment machine learning model includes training the image quality assessment machine learning model using second training data. The second training data differs from the first training data. For example, for training the machine learning classification model, the first training data includes training examples labeled with classification probabilities and the second training data includes training examples labeled with subject quality assessment data. Subsequent to training the image quality assessment machine learning model, the image quality assessment machine learning model is the trained image quality assessment machine learning model.

Although not shown separately in FIG. 4, in some implementations, obtaining the trained image quality assessment machine learning model includes obtaining a trained backbone machine learning model by training the backbone machine learning model as shown in FIG. 4, incorporating the trained backbone machine learning model in an image quality assessment machine learning model, and obtaining the trained image quality assessment machine learning model by training the image quality assessment machine learning model as shown in FIG. 4, except as is described herein or as is otherwise clear from context.

For example, obtaining the trained image quality assessment machine learning model by training the image quality assessment machine learning model that incorporates a trained backbone machine learning model by training the backbone machine learning model, trained as shown in FIG. 4, includes obtaining a second reference image obtained from the second training data, which is similar to obtaining the reference image from the first training data (at 410), except as is described herein or as is otherwise clear from context.

Obtaining the trained image quality assessment machine learning model by training the image quality assessment machine learning model that incorporates a trained backbone machine learning model by training the backbone machine learning model, trained as shown in FIG. 4, includes obtaining a second target image by upscaling a second downscaled image obtained by downscaling a second reference image obtained from the second training data, which is similar to obtaining the reference image from the second training data (at 420), except as is described herein or as is otherwise clear from context.

Obtaining the trained image quality assessment machine learning model by training the image quality assessment machine learning model that incorporates a trained backbone machine learning model by training the backbone machine learning model, trained as shown in FIG. 4, includes obtaining a second adversarial image by upscaling a second optimized distorted image obtained by distorting the second downscaled image, which is similar to obtaining the adversarial image (at 430), except as is described herein or as is otherwise clear from context.

Obtaining the trained image quality assessment machine learning model by training the image quality assessment machine learning model that incorporates a trained backbone machine learning model by training the backbone machine learning model, trained as shown in FIG. 4, includes obtaining, from the image quality assessment machine learning model with third parameter values, a first quality score for the second target image relative to the second reference image, which is similar to obtaining the first result (at 440), except as is described herein or as is otherwise clear from context.

Obtaining the trained image quality assessment machine learning model by training the image quality assessment machine learning model that incorporates a trained backbone machine learning model by training the backbone machine learning model, trained as shown in FIG. 4, includes obtaining, from the image quality assessment machine learning model with the third parameter values, a second quality score for the second adversarial image relative to the second reference image, which is similar to obtaining the second result (at 450), except as is described herein or as is otherwise clear from context.

Obtaining the trained image quality assessment machine learning model by training the image quality assessment machine learning model that incorporates a trained backbone machine learning model by training the backbone machine learning model, trained as shown in FIG. 4, includes obtaining, as fourth parameter values, a result of subtracting a second scaled gradient from the third parameter values, wherein the second scaled gradient is a result of multiplying a second defined learning rate value by a gradient of a second loss function with respect to the third parameter values for the second reference image, wherein the second loss function is a maximum among zero and a result of adding a second defined hinge loss gap hyper-parameter value to a result of subtracting the first quality score from the second quality score, and including the fourth parameter values in the image quality assessment machine learning model, which is similar to obtaining the updated model (at 460), except as is described herein or as is otherwise clear from context.

In some implementations, attack techniques other than the downscaling and upscaling described herein may be used. For example, the distorted examples obtained (at 430) as described herein are obtained by modifying pixel values with a constraint on aggregate, such as overall, pixel change, and another attack technique may include a transform-based attack. In a transform-based attack, the distorted example may be obtained by applying a transformation, such as a blurring transformation, or a brightness transformation, wherein the transformation is parameterized and differentiable. In a transform-based attack, a differentiable transformation (z=T(x; δ)) may apply a transformation with a parameter (δ) to an input example, image or video, (x), such as by increasing brightness and contrast of the input example (x) by the parameter (δ), wherein the optimization goal is arg max ƒ(T(x, δ), y). In some implementations, multiple attack techniques may be used in combination.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “of” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. Other suitable transmitting computing and communication device 100A and receiving computing and communication device 100B implementation schemes are available. For example, the receiving computing and communication device 100B can be a generally stationary personal computer rather than a portable communications device.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
obtaining a trained image quality assessment machine learning model by training a machine learning model using first training data including a reference image, wherein training the machine learning model includes:
obtaining a target image by upscaling a downscaled image obtained by downscaling the reference image;
obtaining an adversarial image by upscaling an optimized distorted image obtained by distorting the downscaled image;
obtaining, from the machine learning model with first parameter values, a first result value for the target image relative to the reference image;
obtaining, from the machine learning model with the first parameter values, a second result value for the adversarial image relative to the reference image;
obtaining, as second parameter values, a result of subtracting a scaled gradient from the first parameter values, wherein the scaled gradient is a result of a product of a defined learning rate value and a gradient of a loss function with respect to the first parameter values for the reference image, wherein the loss function is a maximum among:
zero; and
a result of adding a defined hinge loss gap hyper-parameter value to a result of subtracting the first result value from the second result value; and
including the second parameter values in the machine learning model.

2. The method of claim 1, wherein distorting the downscaled image includes:
obtaining, from the machine learning model, a backpropagated matrix for the target image relative to the reference image;
obtaining, as a first perturbation, a product of a defined step size value and the backpropagated matrix;
obtaining an optimized perturbation by perturbation optimization using the first perturbation as a previously obtained perturbation, wherein perturbation optimization includes:
obtaining, as a current perturbation, a sum of the previously obtained perturbation and a product of the defined step size value and a partial derivative, with respect to the previously obtained perturbation, of the machine learning model with respect to the reference image as applied to a current distorted image obtained by upscaling a sum of the downscaled image and the previously obtained perturbation;
determining whether one or more exit conditions are unsatisfied;
in response to obtaining a determination that the one or more exit conditions are unsatisfied, obtaining, as the current perturbation, a perturbation obtained by perturbation optimization using the current perturbation as the previously obtained perturbation; and
in response to obtaining a determination that at least one of the one or more exit conditions is satisfied, using the current perturbation as the optimized perturbation; and
obtaining, as the optimized distorted image, a sum of the downscaled image and the optimized perturbation.

3. The method of claim 2, wherein:
perturbation optimization includes incrementing a perturbation optimization iteration count value; and
obtaining the determination that the one or more exit conditions are unsatisfied includes determining that the perturbation optimization iteration count value is less than a defined maximum iterations threshold.

4. The method of claim 2, wherein perturbation optimization includes:
prior determining whether the one or more exit conditions are unsatisfied, using the current perturbation as an unconstrained candidate perturbation and obtaining, as the current perturbation, a result of a product of the unconstrained candidate perturbation and a result of dividing a minimum among a defined norm constraint value and a Euclidean norm of the unconstrained candidate perturbation by the Euclidean norm of the unconstrained candidate perturbation.

5. The method of claim 1, wherein:
subsequent to training the machine learning model, the machine learning model is the trained image quality assessment machine learning model.

6. The method of claim 1, wherein:
the machine learning model is a machine learning classification model; and
obtaining the trained image quality assessment machine learning model includes:
obtaining an image quality assessment machine learning model that includes the machine learning model as a backbone model; and
subsequent to training the machine learning model, training the image quality assessment machine learning model using second training data including a second reference image, wherein subsequent to training the image quality assessment machine learning model, the image quality assessment machine learning model is the trained image quality assessment machine learning model.

7. The method of claim 6, wherein training the image quality assessment machine learning model includes:
obtaining a second target image by upscaling a second downscaled image obtained by downscaling the second reference image;
obtaining a second adversarial image by upscaling a second optimized distorted image obtained by distorting the second downscaled image;
obtaining, from the image quality assessment machine learning model with third parameter values, a first quality score for the second target image relative to the second reference image;
obtaining, from the image quality assessment machine learning model with the third parameter values, a second quality score for the second adversarial image relative to the second reference image;
obtaining, as fourth parameter values, a result of subtracting a second scaled gradient from the third parameter values, wherein the second scaled gradient is a result of multiplying a second defined learning rate value by a gradient of a second loss function with respect to the third parameter values for the second reference image, wherein the second loss function is a maximum among:
zero; and
a result of adding a second defined hinge loss gap hyper-parameter value to a result of subtracting the first quality score from the second quality score; and
including the fourth parameter values in the image quality assessment machine learning model.

8. The method of claim 1, wherein:
the first training data includes a plurality of reference images, including the reference image; and
training the machine learning model includes training the machine learning model on a per-reference-image basis with respect to the plurality of reference images.

9. The method of claim 1, wherein:
the trained image quality assessment machine learning model is a trained video quality assessment machine learning model;
the first training data includes a plurality of reference videos, including a first reference video, wherein the reference image is a first frame of the first reference video; and
training the machine learning model includes training the machine learning model on a per-reference-video basis with respect to the plurality of reference videos.

10. An apparatus comprising:
a non-transitory computer readable medium; and
a processor configured to execute instructions stored on the non-transitory computer readable medium to:
obtain a trained image quality assessment machine learning model, wherein, to obtain the train image quality assessment machine learning model, the processor executes the instructions to train a machine learning model using first training data including a reference image, wherein, to train the machine learning model, the processor executes the instructions to:
obtain a target image, wherein, to obtain the target image, the processor executes the instructions to upscale a downscaled image, wherein, to obtain the downscaled image, the processor executes the instructions to downscale the reference image;
obtain an adversarial image, wherein, to obtain the adversarial image, the processor executes the instructions to upscale an optimized distorted image, wherein, to obtain the optimized distorted image, the processor executes the instructions to distort the downscaled image;
obtain, from the machine learning model with first parameter values, a first result value for the target image relative to the reference image;
obtain, from the machine learning model with the first parameter values, a second result value for the adversarial image relative to the reference image;
obtain, as second parameter values, a result of subtraction of a scaled gradient from the first parameter values, wherein the scaled gradient is a result of a product of a defined learning rate value and a gradient of a loss function with respect to the first parameter values for the reference image, wherein the loss function is a maximum among:
zero; and
a result of addition of a defined hinge loss gap hyper-parameter value to a result of subtraction of the first result value from the second result value; and
include the second parameter values in the machine learning model.

11. The apparatus of claim 10, wherein, to distort the downscaled image, the processor executes the instructions to:
obtain, from the machine learning model, a backpropagated matrix for the target image relative to the reference image;
obtain, as a first perturbation, a product of a defined step size value and the backpropagated matrix;
obtain an optimized perturbation by perturbation optimization with the first perturbation as a previously obtained perturbation, wherein, to perform perturbation optimization, the processor executes the instructions to:
obtain, as a current perturbation, a sum of the previously obtained perturbation and a product of the defined step size value and a partial derivative, with respect to the previously obtained perturbation, of the machine learning model with respect to the reference image as applied to a current distorted image, wherein, to obtain the current distorted image, the processor executes the instructions to upscale a sum of the downscaled image and the previously obtained perturbation;
determine whether one or more exit conditions are unsatisfied;
in response to a determination that the one or more exit conditions are unsatisfied, obtain, as the current perturbation, a perturbation obtained by perturbation optimization with the current perturbation as the previously obtained perturbation; and
in response to a determination that at least one of the one or more exit conditions is satisfied, use the current perturbation as the optimized perturbation; and
obtain, as the optimized distorted image, a sum of the downscaled image and the optimized perturbation.

12. The apparatus of claim 11, wherein:
to perform perturbation optimization, the processor executes the instructions to increment a perturbation optimization iteration count value; and
to obtain the determination that the one or more exit conditions are unsatisfied, the processor executes the instructions to determine that the perturbation optimization iteration count value is less than a defined maximum iterations threshold.

13. The apparatus of claim 11, wherein perturbation optimization includes:
prior the determination whether the one or more exit conditions are unsatisfied, use the current perturbation as an unconstrained candidate perturbation and obtain, as the current perturbation, a result of a product of the unconstrained candidate perturbation and a result of division of a minimum among a defined norm constraint value and a Euclidean norm of the unconstrained candidate perturbation by the Euclidean norm of the unconstrained candidate perturbation.

14. The apparatus of claim 10, wherein:
the machine learning model is a machine learning classification model; and
to obtain the trained image quality assessment machine learning model, the processor executes the instructions to:
obtain an image quality assessment machine learning model that includes the machine learning model as a backbone model; and
subsequent to training the machine learning model, train the image quality assessment machine learning model with second training data that includes a second reference image, wherein subsequent to training the image quality assessment machine learning model, the image quality assessment machine learning model is the trained image quality assessment machine learning model.

15. The apparatus of claim 10, wherein:
the first training data includes a plurality of reference images that includes the reference image; and
to train the machine learning model, the processor executes the instructions to train the machine learning model on a per-reference-image basis with respect to the plurality of reference images.

16. The apparatus of claim 10, wherein:
the trained image quality assessment machine learning model is a trained video quality assessment machine learning model;
the first training data includes a plurality of reference videos that includes a first reference video, wherein the reference image is a first frame of the first reference video; and
to train the machine learning model, the processor executes the instructions to train the machine learning model on a per-reference-video basis with respect to the plurality of reference videos.

17. A non-transitory computer-readable storage medium, comprising executable instructions that, when executed by a processor, facilitate performance of operations, comprising:
obtaining a trained image quality assessment machine learning model by training a machine learning model using first training data including a reference image, wherein training the machine learning model includes:
obtaining a target image by upscaling a downscaled image obtained by downscaling the reference image;
obtaining an adversarial image by upscaling an optimized distorted image obtained by distorting the downscaled image;
obtaining, from the machine learning model with first parameter values, a first result value for the target image relative to the reference image;
obtaining, from the machine learning model with the first parameter values, a second result value for the adversarial image relative to the reference image;
obtaining, as second parameter values, a result of subtracting a scaled gradient from the first parameter values, wherein the scaled gradient is a result of a product of a defined learning rate value and a gradient of a loss function with respect to the first parameter values for the reference image, wherein the loss function is a maximum among:
zero; and
a result of adding a defined hinge loss gap hyper-parameter value to a result of subtracting the first result value from the second result value; and
including the second parameter values in the machine learning model.

18. The non-transitory computer-readable storage medium of claim 17, wherein distorting the downscaled image includes:
obtaining, from the machine learning model, a backpropagated matrix for the target image relative to the reference image;
obtaining, as a first perturbation, a product of a defined step size value and the backpropagated matrix;
obtaining an optimized perturbation by perturbation optimization using the first perturbation as a previously obtained perturbation, wherein perturbation optimization includes:
obtaining, as a current perturbation, a sum of the previously obtained perturbation and a product of the defined step size value and a partial derivative, with respect to the previously obtained perturbation, of the machine learning model with respect to the reference image as applied to a current distorted image obtained by upscaling a sum of the downscaled image and the previously obtained perturbation;
determining whether one or more exit conditions are unsatisfied;
in response to obtaining a determination that the one or more exit conditions are unsatisfied, obtaining, as the current perturbation, a perturbation obtained by perturbation optimization using the current perturbation as the previously obtained perturbation; and
in response to obtaining a determination that at least one of the one or more exit conditions is satisfied, using the current perturbation as the optimized perturbation; and
obtaining, as the optimized distorted image, a sum of the downscaled image and the optimized perturbation.

19. The non-transitory computer-readable storage medium of claim 18, wherein perturbation optimization includes:
prior determining whether the one or more exit conditions are unsatisfied, using the current perturbation as an unconstrained candidate perturbation and obtaining, as the current perturbation, a result of a product of the unconstrained candidate perturbation and a result of dividing a minimum among a defined norm constraint value and a Euclidean norm of the unconstrained candidate perturbation by the Euclidean norm of the unconstrained candidate perturbation.

20. The non-transitory computer-readable storage medium of claim 17, wherein:
the machine learning model is a machine learning classification model; and
obtaining the trained image quality assessment machine learning model includes:
obtaining an image quality assessment machine learning model that includes the machine learning model as a backbone model; and
subsequent to training the machine learning model, training the image quality assessment machine learning model using second training data including a second reference image, wherein subsequent to training the image quality assessment machine learning model, the image quality assessment machine learning model is the trained image quality assessment machine learning model.
